(19) United States
(12) Patent Application Publication
(10) Pub. No.: US 2013/0081905 A1
(43) Pub. Date: Apr. 4, 2013

(54) BRAKE ASSEMBLY

(71) Applicants: Juan Antonio Illan, Madrid (ES); Jose Maria Sandoval, Madrid (ES); Juan Martin-Martin, Madrid (ES); Antonio Sanchez-Palenzuela, Madrid (ES)

(72) Inventors: Juan Antonio Illan, Madrid (ES); Jose Maria Sandoval, Madrid (ES); Juan Martin-Martin, Madrid (ES); Antonio Sanchez-Palenzuela, Madrid (ES)

(73) Assignee: OTIS ELEVATOR COMPANY, Farmington, CT (US)

(21) Appl. No.: 13/703,649

(22) PCT Filed: Jun. 15, 2010
(86) PCT No.: PCT/US10/38639

§ 371 Date: Dec. 12, 2012

(30) Foreign Application Priority Data
Jun. 15, 2010 (US) PCT/US2010/038639

(51) Int. Cl. B66B 1/36; F16D 65/092; F16D 55/02

(52) U.S. Cl. CPC B66B 1/36; F16D 55/02; F16D 65/092
USPC 187/276; 188/71.1; 188/251 A

(57) ABSTRACT

An elevator brake component used in a friction brake of an elevator includes a metal plate that is frictionally engaged with another brake component when the elevator brake is engaged. The plate includes a non-stick finish on the metal plate on a surface of the plate that is frictionally engaged when the elevator brake is engaged by the other brake component.

### BACKGROUND OF THE INVENTION

Typical elevator systems can include an elevator car attached to a counterweight by roping. A drive machine, which includes a motor and a brake, rotates and acts (typically by traction) on the roping (that could be round ropes or flat belts) that engages the machine to move the elevator car and counterweight up and down an elevator hoistway, transporting passengers or cargo from one floor to another. An elevator controller controls operation of the elevator system. The drive machine is typically located at the top of the hoistway.

When an elevator call is registered, the controller sends a signal to the drive machine to raise or lower the car to the call floor, and then apply the brake on the machine as the elevator approaches the call floor. One possible brake for the drive machine is a clutch brake, which consists of a fixed plate, a movable plate, springs and an electromagnet for moving the movable plate, and a liner located between the fixed plate and the movable plate and attached to a shaft which rotates with the drive machine when the elevator car is being moved. When braking is needed, the movable plate is moved towards the fixed plate by springs, bringing the liner into contact with both the movable plate and the fixed plate. The frictional forces from the contact of the fixed plate, the liner and the movable plate stop the rotational movement of the liner. As the liner is connected to the shaft, this stopping translates to the shaft and the drive machine, and stops the movement of the elevator car. When the elevator needs to move again, the controller sends a signal, and current is sent to the electromagnet to pull the movable plate away from the liner and the fixed plate, allowing rotational movement of the liner and shaft, and movement of the car.

Whenever the electromagnets are not energized, the springs force the movable plate toward the fixed plate, and bring the liner into contact with the plates.

There are various circumstances (both before and after installation of the machine in the elevator hoistway) in which the electromagnets may not be energized, for example, during transportation of the machine to the job site or while the machine resides at the job site awaiting installation in the hoistway. After installation, the electromagnets are not energized, for example, during power loss to the building or the elevator system, during periods of inactivity of the elevator system, or while the elevator system is in a “sleep mode.”

Under certain conditions, prolonged contact between the liner and the plates may cause the liner to stick to the moveable plate and/or the fixed plate. When subsequently energizing the electromagets, the liner may not disengage from the moveable plate and/or the fixed plate. Without disengagement of the liner and plate(s), the machine may not be able to operate since the liner/plate sticking prevents the shaft from rotating. In an installed elevator system, the controller will sense the inability of the machine shaft to rotate, and shut down the elevator system. A technician must then visit to resolve the issue.

With machineroomless elevator systems (in which the machine resides in the hoistway rather than in a conventional machine room), this brake sticking scenario can prove difficult and/or time consuming to remedy. A technician typically accesses the machine in the hoistway by travelling on the top of the car until it reaches the top of the hoistway. With the machine inoperative, the technician must find another way to access the machine in the hoistway.

### BRIEF SUMMARY OF THE INVENTION

An elevator brake component used in a friction brake of an elevator includes a metal plate that is frictionally engaged with another brake component when the elevator brake is engaged. The plate includes a non-stick finish on the metal plate on a surface of the plate that is frictionally engaged when the elevator brake is engaged by the other brake component.

### BRIEF DESCRIPTION OF THE DRAWINGS

FIG. 1 is an exploded view of one possible embodiment of an elevator drive machine including a clutch brake.

FIG. 2 is a close-up exploded view of another possible embodiment of a clutch brake assembly for an elevator drive machine.

FIG. 3 is a perspective view of one possible embodiment of a caliper brake assembly for an elevator.

### DETAILED DESCRIPTION

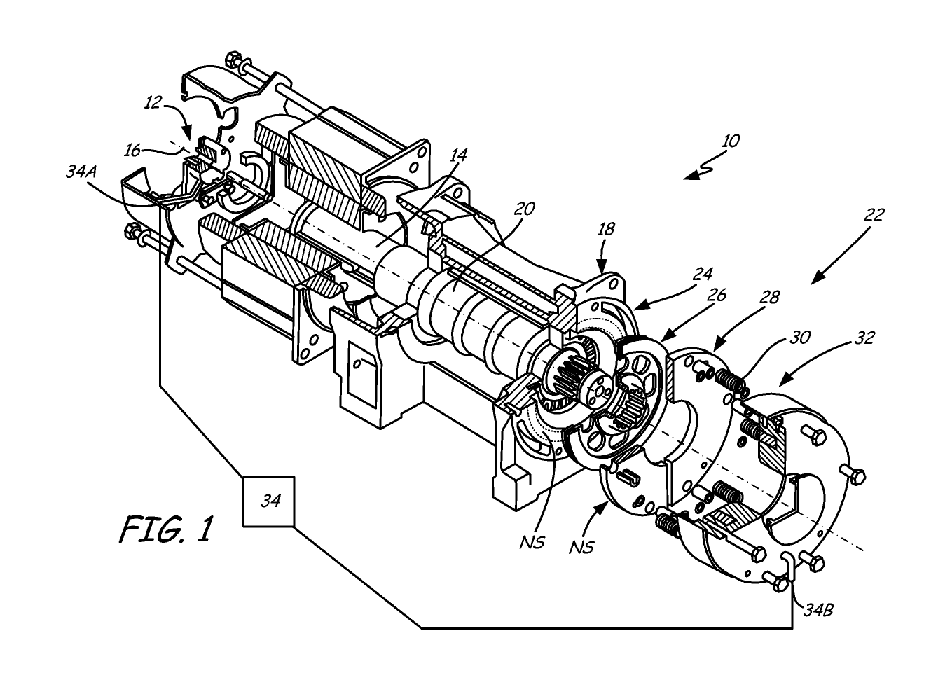

FIG. 1 is an exploded view of one possible embodiment of an elevator drive machine including a clutch brake assembly. Elevator drive machine 10 could be, for example, a gearless permanent magnet machine that includes an electric motor 12, shaft 14 which rotates around axis 16, housing 18, sheave 20 brake assembly 22 for applying a braking force to the machine 10 such as through the shaft 14 and electrical wiring 34A, 34B connecting the machine to controller 34, located at any suitable location. As will be explained in further detail below, the brake assembly 22 includes fixed plate 24, liner 26, movable plate 28, springs 30, and housing 32 that includes electromagnet 33.

Motor 12 is connected to shaft 14 to rotationally drive shaft 14. Shaft 14 also connects to sheave 20 (alternatively, sheave 20 could be an integral part of shaft 14) and liner 26. Fixed plate 24 is part of housing 18 in this embodiment. Movable plate 28 (which could be an annular disk or formed from multiple segments as seen in FIG. 1) surrounds shaft 14 and is to be acted on by two forces, the force of springs 30 moving it towards liner 26 (to provide a braking force) and the magnetic field from electromagnet 33, moving movable plate 28 away from liner 26. Motor 12, shaft 14, sheave 20 and brake assembly 22 are all fixed around axis 16. Controller 34 is connected to drive machine 10 through wiring 34A at motor and 34B at electromagnet 33.

To move an elevator car up and down in a hoistway, controller 34 sends drive signals through wiring 34A to motor 12 to rotationally drive shaft 14 about axis 16. Rotation of shaft 14 is translated to sheave 20, which rotates and, typically through traction, drives the roping to raise or lower the elevator car and counterweight, depending on which way drive signals sent to motor cause motor to rotationally drive shaft 14.

Brake assembly 22 is connected to rotating shaft 14 through liner 26, for example, using splines 25A on shaft 14 that engage grooves 25B on a hub of the liner 26. This connection causes liner to rotate with shaft 14. The brake assembly 22 also secures to the non-rotating portion of the machine 10, for example by fastening the housing 32 of the brake assembly 22 to the housing 18 using bolts.

When the elevator is in operation and controller 34 is sending drive signals through wiring 34A to motor 12 to rotationally drive shaft 14, controller 34 also sends current through wiring 34B to electromagnet 33 to produce a magnetic field that causes movable plate 28 to move axially toward brake housing 32. The movement of movable plate away from fixed plate 24 allows liner 26 to rotate with shaft 14. When braking is desired, for example when elevator car approaches a desired destination, controller 34 stops sending current to electromagnet 33, and movable plate 28 then moves axially towards liner 26 due to the force of springs 30. Springs 30 move movable plate 28 axially away from the brake housing 32 so that movable plate 28 pushes liner 26 into contact with fixed plate 24 and movable plate 28. The resulting friction from the contact with fixed plate 24 and movable plate 28 stops liner 26 from rotating. This stopping of rotation is translated to shaft 14, sheave 20 and the roping, resulting in stopping of movement of the elevator car up or down in the hoistway.

As will be discussed in further detail below, fixed plate 24 and/or the movable plate 28 has a finish thereon that reduces the likelihood of liner 26 sticking to the plates 24, 28.

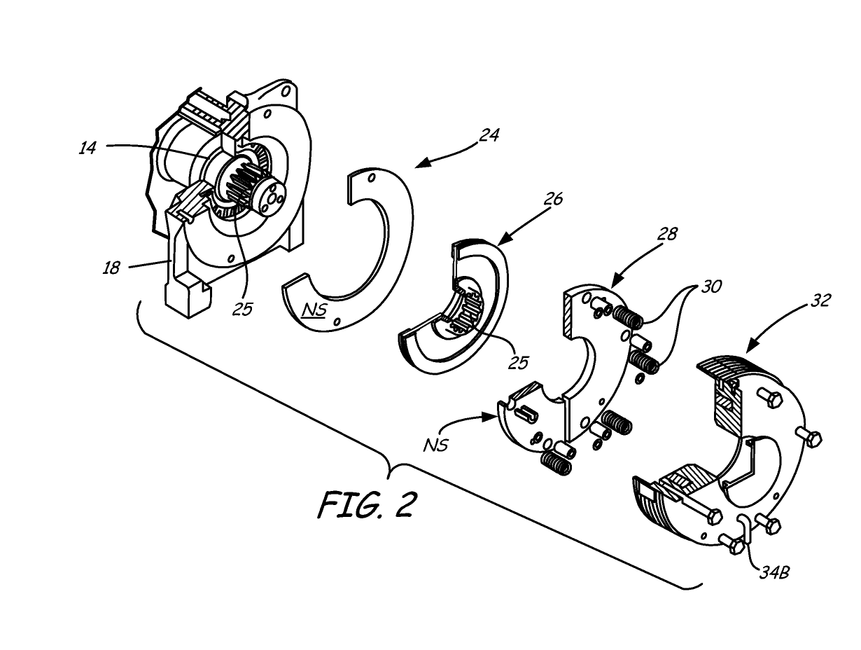

FIG. 2 shows an exploded view of another embodiment of an elevator drive machine (partially shown) including an elevator brake assembly. Machine 10 could be, for example, a gearless permanent magnet machine that includes an electric motor (not shown), shaft 14, housing 18, fixed plate 24, liner 26, movable plate 28, springs 30, housing 32 that includes electromagnet 33 and controller connection 34B. Fixed plate 24 is fixed to housing 18, for example by using fasteners. Liner 26 is connected to shaft 14 through spline connection to rotate with shaft 14. Movable plate 28 (which again could be an annular disk or formed from multiple segments as seen in FIG. 2) is urged by electromagnet 33 and springs 30, to move axially towards and away from liner 26 depending on signals received from controller through controller connection 34B. Liner 26 can be a metal plate, such as the annular disk shown in FIG. 1 and FIG. 2, having friction material thereon, such as NF-410B available from Carlisle of Bloomington, Ind., USA, T566 available from Raybestos of McHenry, Ill., USA, or other appropriate friction materials.

As mentioned above, when elevator car is moving up or down in the hoistway, shaft 14 rotates, rotating liner 26. During that time, electromagnet 33 receives current, moving movable plate 28 away from liner 26, allowing liner 26 to rotate freely. When car is stopped, current to electromagnet 33 is stopped, and movable plate 28 is moved axially towards liner 26 by springs 30. This movement moves liner 26 into contact with one side of fixed plate 24 and with one side of movable plate 28. The friction between the surfaces of liner 26 with one side of fixed plate 24 and one side of movable plate 28 stops the rotational movement of liner 26. Due to the splined connection 25, rotational movement of shaft 14 is also stopped. This stopping of rotational movement of shaft 14 then stops the movement of car up or down within the hoistway. Movable plate 28 is moved axially against the compressive force of springs 30 toward electromagnet 33 by current flowing through electromagnet 33. When there is a loss of power to the elevator system, no current is sent through electromagnet 33, and movable plate 28 is released to be moved towards liner 26 by springs 30. This ensures that movable plate 28 is moved axially towards liner 26, to stop car movement in the event of a loss of power to the elevator system.

In some instances, when plates 24, 28 and liner 26 are moved together to frictionally stop movement of the elevator car, certain conditions cause the plates 24, 28 and liner 26 to stick together, preventing further elevator movement. This frequently occurs in humid climates or in situations where the elevator is used infrequently, such as in sports stadiums where games may be played only once per week. This also may occur when shipping an elevator brake assembly, where it may come into contact with moisture through the shipping process or while waiting to be installed. When the fixed plate 24, liner 26 and movable plate 28 have been held together by springs 30 for prolonged periods of time (for example a week or more between games in the case of a sports stadium) or for weeks during shipping and/or exposed to moisture, the plates can stick to liner 26, and can remain stuck together even after the electromagnet 33 receives current to move movable plate 28 away from fixed plate 24 and liner 26. When this happens, the elevator sends an error signal back to the controller, and a technician must come to inspect the problem. This often results in having to replace the entire braking assembly, resulting in an extended period of time in which the elevator is unable to be used and in high replacement costs.

The current invention seeks to solve this problem by inclusion of a finish (which should be interpreted to include the use of a material) on at least the side of fixed plate 24 and/or movable plate 28 that comes into contact with liner that reduces the likelihood of liner 26 sticking to the plates 24, 28. Preferably, the finish eliminates any sticking between liner 26 and plates 24, 28. However, it is still within the scope of this invention for the finish to reduce sticking between liner 26 and plates 24, 28 (measured by torque) below the level of sticking with conventional materials. Either possibility previously discussed (i.e. eliminating or reducing sticking) is hereinafter referred to as being non-stick. This non-stick finish can be done in several ways, depending on the material which fixed plate 24 and movable plate 28 are made of. If fixed plate 24 and movable plate 28 are made of regular steel, the plate is given a low-roughness finish and coated with black oxide. To achieve the low-roughness finish the steel plate can be placed in a tumbler with abrasive materials such as rocks and sand. It can be spun around or tumbled in the tumbler to bring the surface of the plate into contact with the abrasive materials. The abrasive materials rid the steel plate of micro peaks that occur when forming the plate, thereby lowering the roughness of the surface of the plate. The plate then gets a black oxide coating for corrosion resistance. This low-roughness steel plate with black oxide generally results in a roughness of about 0.12 Ra to about 0.25 Ra. Alternatively, fixed plate 24 and movable plate 28 can be made of stainless steel with the non-stick finish being a mirror finish. The roughness of the stainless steel plate with a mirror finish can be about 0.03 Ra to about 0.07 Ra.

The non-stick finish on at least the side of fixed plate 24 and/or movable plate 28 that comes into contact with liner 26 greatly reduces the possibility of sticking of the plates 24, 28 in brake assembly 22, even in the situations where sticking was prevalent such as situations of infrequent elevator use and elevators in humid climates. This reduces both the time during which the elevator is inoperable and the cost of replacing the brake in which the plates stuck. Additionally this invention can help eliminate the need to replace brake assemblies that have been exposed to moisture during the shipment process, causing them to be stuck together even before the first use.

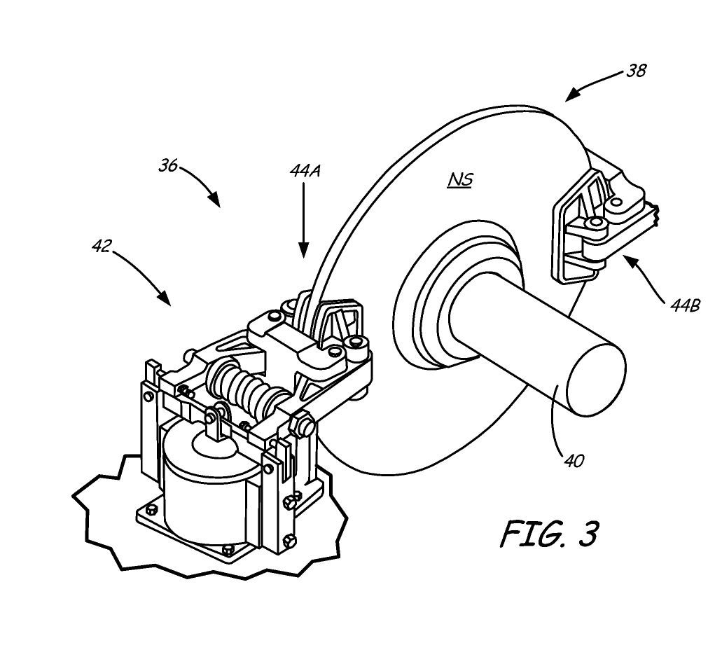

FIG. 3 is a perspective view of one possible embodiment of a disk brake for an elevator using a plate with a non-stick finish according to the present invention. Disk brake assembly 36 includes brake plate 38 with non-stick finish NS, shaft 40, and braking assembly 42 (which includes clutches 44A, 44B). Disk brake assembly 36 is another type of brake that can be used in stopping the movement of an elevator car within a hoistway. As in the clutch brakes of FIG. 1-FIG. 2, the stopping is done through friction between brake plate 38 and another component of the brake, in this case, clutches 44A, 44B.

Shaft 40 connects to a sheave and motor (not shown) to rotate therewith to move elevator car up and down in a hoistway. Shaft 40 connects to plate 38 so that plate 38 rotates with shaft 40 (much in the same way as shaft 14 and liner 26 of FIGS. 1-2). Disk brake assembly 36 operates to clutch brake plate 38 with clutches 44A, 44B when braking is desired.

When a signal to brake is sent from controller (not shown), braking assembly 42 operates clutches 44A, 44B to clamp down on both sides of brake plate 38 to stop the rotation of brake plate 38 through frictional force. This stopping of the rotation of brake plate 38 stops the rotational movement of shaft 40, stopping the movement of the elevator car in the hoistway.

When the brake is exposed to moisture or when the brake has been engaged for a period of time, sticking sometimes occurs between brake plate 38 and clutches 44A, 44B, preventing clutches 44A, 44B from releasing. This prevents brake plate 38 and shaft 40 from rotating, therefore preventing elevator to move within the hoistway. This sticking often results in the need to replace the brake, adding expense and inconvenience of the elevator being out of service for a period of time. By using a brake plate with a non-stick finish according to the current invention in disk brake assembly 36, incidents of sticking are greatly reduced or eliminated. The non-stick finish can be a mirror finish for brake plate 38 made of stainless steel, resulting in a roughness of about 0.03 Ra to about 0.07 Ra. The non-stick finish can also be a low-roughness finish with black oxide for brake plate 38 made of steel, resulting in a roughness of about 0.12 Ra to about 0.25 Ra.

In summary, replacing the brake plate of an elevator brake assembly with a brake plate with non-stick finish according to the current invention greatly reduces the likelihood of the brake plate sticking in an elevator braking assembly. This reduces the expense of replacing brakes which have become stuck, as well as keeps elevators running smoothly without service interruptions, even in situations where an elevator may sit with the brake engaged and the car not moving for a week or more (such as at a sports stadium). Furthermore, this eliminates some of the restrictions on shipping of brakes which do not include brake plates with the non-stick finish according to the current invention, including having to ensure the brake assembly is kept away from moisture on ships and out of elements such as rain prior to installation within a hoistway.

While the invention has been described with reference to an exemplary embodiment(s), it will be understood by those skilled in the art that various changes may be made and equivalents may be substituted for elements thereof without departing from the scope of the invention. For example, a different type of brake (other than the ones shown in FIG. 1-FIG. 3) using friction as a stopping means could use the brake plate with the non-stick finish. In addition, as an alternative to adding a non-stick finish to a brake plate, a brake plate could be produced having a low roughness surface. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A brake for an elevator, the brake comprising:
a fixed plate;
a movable plate, movable axially toward and away from the fixed plate; and
a liner between the fixed plate and the movable plate to stop movement of the elevator when in contact with the movable plate and the fixed plate; wherein at least one of the movable plate and the fixed plate has a finish that reduces the likelihood of the liner sticking to at least one of the plates.

2. The brake of claim 1, wherein one or both of the fixed plate and the movable plate is made of stainless steel.

3. The brake of claim 2, wherein the finish on the one or both of the fixed plate and the movable plate that is made of stainless steel comprises a mirror finish on at least each side which is to come into contact with the liner when moved by the movable plate.

4. The brake of claim 3, wherein the minor finish has a roughness of about 0.07 Ra or less.

5. The brake of claim 1, wherein one or both of the fixed plate and the movable plate is made of steel.

6. The brake of claim 5, wherein the finish on the one or both of the fixed plate and the movable plate that is made of steel comprises a low-roughness finish with a black oxide coating.

7. The brake of claim 6, wherein the finish has a roughness of about 0.25 Ra or less on at least each side which is to come into contact with the liner when moved by the movable plate.

8. The brake of claim 1, and further comprising
an electro magnet to move the movable plate away from the fixed plate;
springs to move the movable plate towards the fixed plate;
a drive machine to drive the elevator up and down in a hoistway; and
a shaft connected to the drive machine to rotate with the drive machine when the elevator is travelling up or down in the hoistway, wherein the liner is connected to the shaft to rotate with the shaft when the elevator is travelling up and down in the hoistway and the liner stops the motion of the elevator by stopping the rotational motion of the shaft when the rotational movement of the liner is stopped through frictional forces from contact with the movable plate and the fixed plate when the springs move the movable plate towards the fixed plate.

9. The brake of claim 1, wherein the liner comprises:
a metal disk with a lining fixed to each side.

10. The brake of claim 9, wherein the lining is fixed to the metal disk by gluing or by directly molding onto the disk.

11. An elevator brake component to be used in a friction brake of an elevator, the brake component comprising:
a metal plate to be frictionally engaged with another brake component when the elevator brake is engaged; and
a non-stick finish on the metal plate on a surface of the plate that will be frictionally engaged when the elevator brake is engaged by the other brake component.

12. The elevator brake component of claim 11, wherein the non-stick finish has a roughness of about 0.25 Ra or less.

13. The elevator brake component of claim 12, wherein the metal plate is made of steel.

14. The brake component of claim 13, wherein the non-stick finish further includes a black oxide finish.

15. The elevator brake component of claim 11, wherein the metal plate is made of stainless steel.

16. The elevator brake component of claim 15, wherein the non-stick finish is a minor finish with a roughness of about 0.07 Ra or less.

17. A brake for an elevator, the brake comprising:
a fixed plate;
a movable plate, movable axially toward and away from the fixed plate; and
a liner between the fixed plate and the movable plate to stop movement of the elevator when in contact with the movable plate and the fixed plate;
wherein at least one of the plates has a low roughness finish.

18. The brake of claim 17, wherein the low roughness finish has a roughness of approximately 0.25 Ra or less.

19. The brake of claim 18, wherein the low roughness finish has a roughness of approximately 0.07 Ra or less.

20. An elevator brake component to be used in a friction brake of an elevator, the brake component comprising:
a metal plate to be frictionally engaged with another brake component when the elevator brake is engaged; and
a low roughness finish on the metal plate on a surface of the plate that will be frictionally engaged when the elevator brake is engaged by the other brake component.
